(19) United States
(12) Patent Application Publication
(10) Pub. No.: US 2026/0016960 A1
(43) Pub. Date: Jan. 15, 2026

(54) I/O Prioritization During Model Load

(71) Applicant: Sandisk Technologies, Inc., Milpitas, CA (US)

(72) Inventors: Judah Gamliel HAHN, Ofra (IL); Lip Vui KAN, Singapore (SG)

(73) Assignee: Sandisk Technologies, Inc., Milpitas, CA (US)

(21) Appl. No.: 19/265,663

(22) Filed: Jul. 10, 2025

Related U.S. Application Data
(60) Provisional application No. 63/671,330, filed on Jul. 15, 2024.

(51) Int. Cl. G06F 3/06

(52) U.S. Cl. CPC G06F 3/0611; G06F 3/0659; G06F 3/0679

(57) ABSTRACT

When model loading, properly prioritizing input/output (I/O) commands from a host device is valuable to ensure efficient data storage device operation without over pressuring volatile memory of the data storage device. The data storage device receives a command and then determines the priority for the command. The priority can be determined in numerous manners such as checking the host side context attributes, identifying synchronous writes, identifying long sequential reads, and checking a host memory address used for a write, to name only a few. Once identified, I/O prioritization can be selectively applied when a model load is occurring. In so doing, efficient operation of the data storage device is achieved with minimal volatile memory pressure during the model loading.

### CROSS-REFERENCE TO RELATED APPLICATIONS

This application claims benefit of U.S. Provisional Patent Application Ser. No. 63/671,330, filed Jul. 15, 2024, which is herein incorporated by reference.

### BACKGROUND OF THE DISCLOSURE

### Field of the Disclosure

Embodiments of the present disclosure generally relate to prioritizing commands during model loading.

### Description of the Related Art

Client compute environments are increasingly incorporating artificial intelligence (AI) features to improve end-user productivity. AI features are implemented by using pre-trained models stored locally on the user's platform and running inferences via integrated graphics processing units (GPUs) or neural processing units (NPUs). AI personal computers (PCs) are planned for launch in 2024 by numerous original equipment manufacturers (OEMs), leveraging new features from numerous chip makers that enhance AI capabilities.

The role of storage in AI PCs is to load the model, typically via a sequential read, into memory, such as volatile memory (e.g., dynamic random access memory (DRAM)) as quickly as possible. While there are future research directions in which the solid state devices (SSDs) play a larger part in the inference, either via segmentation, paging, or local computation, the simple case of loading the model presents some challenges.

Model sizes are relatively small at this point in time. However, it is anticipated that model sizes will increase, which will lead to inefficient data storage device operation due to limited volatile memory capacity.

Therefore, there is a need in the art for improved capabilities to handle model loading in data storage devices.

### SUMMARY OF THE DISCLOSURE

When model loading, properly prioritizing input/output (I/O) commands from a host device is valuable to ensure efficient data storage device operation without over pressuring volatile memory of the data storage device. The data storage device receives a command and then determines the priority for the command. The priority can be determined in numerous manners such as checking the host side context attributes, identifying synchronous writes, identifying long sequential reads, and checking a host memory address used for a write, to name only a few. Once identified, I/O prioritization can be selectively applied when a model load is occurring. In so doing, efficient operation of the data storage device is achieved with minimal volatile memory pressure during the model loading.

In one embodiment, a data storage device comprises: a memory device; and a controller coupled to the memory device, wherein the controller is configured to: perform a model load operation; receive a command from a host device during the performing; determine whether the command is a paging input/output (I/O) write command, wherein the determining occurs during the performing; and prioritize command execution based upon the determination, wherein the prioritizing occurs during the performing.

In another embodiment, a data storage device comprises: a memory device; and a controller coupled to the memory device, wherein the controller is configured to: receive a plurality of write commands from a host device; determine and set priority for the plurality of write commands; and execute at least one write command of the plurality of write command while performing a model loading operation, wherein at least a second write command of the plurality of write commands is executed after performing the model loading operation.

In another embodiment, a data storage device comprises: means to store data; and a controller coupled to the means to store data, wherein the controller is configured to: prioritize command received during a model load operation, wherein the prioritizing comprises taking into consideration the following: whether the command is a long sequential read command; whether the command is a write command from a host memory range near a last model load read; and whether the command is a paging input/output (I/O) write command.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic block diagram illustrating a storage system in which a data storage device may function as a storage device for a host device, according to certain embodiments.

FIG. 2 is a schematic illustration of a storage trace according to one embodiment.

FIG. 3 is a schematic illustration of a text to video trace according to one embodiment.

FIG. 4 is a schematic illustration of model loading with paging according to one embodiment.

FIG. 5 is an illustration of nonvolatile memory express (NVMe) dataset management context attributes.

FIG. 6 is a flowchart illustrating prioritizing commands during model loading according to one embodiment.

FIG. 7 is a flowchart illustrating identification of a paging I/O command according to one embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

When model loading, properly prioritizing input/output (I/O) commands from a host device is valuable to ensure efficient data storage device operation without over pressuring volatile memory of the data storage device. The data storage device receives a command and then determines the priority for the command. The priority can be determined in numerous manners such as checking the host side context attributes, identifying synchronous writes, identifying long sequential reads, and checking a host memory address used for a write, to name only a few. Once identified, I/O prioritization can be selectively applied when a model load is occurring. In so doing, efficient operation of the data storage device is achieved with minimal volatile memory pressure during the model loading.

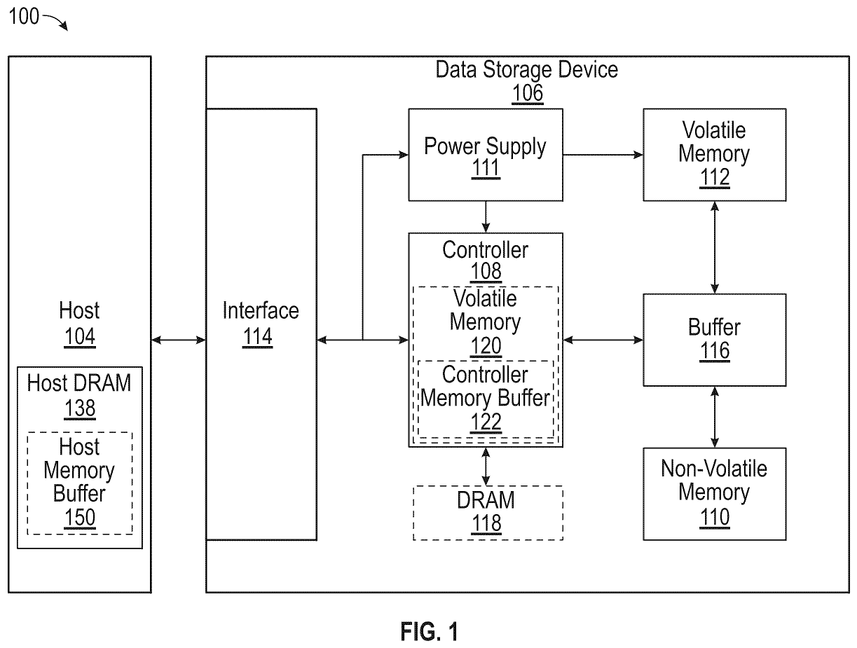

FIG. 1 is a schematic block diagram illustrating a storage system 100 having a data storage device 106 that may function as a storage device for a host device 104, according to certain embodiments. For instance, the host device 104 may utilize a non-volatile memory (NVM) 110 included in data storage device 106 to store and retrieve data. The host device 104 comprises a host dynamic random access memory (DRAM) 138. In some examples, the storage system 100 may include a plurality of storage devices, such as the data storage device 106, which may operate as a storage array. For instance, the storage system 100 may include a plurality of data storage devices 106 configured as a redundant array of inexpensive/independent disks (RAID) that collectively function as a mass storage device for the host device 104.

The host device 104 may store and/or retrieve data to and/or from one or more storage devices, such as the data storage device 106. As illustrated in FIG. 1, the host device 104 may communicate with the data storage device 106 via an interface 114. The host device 104 may comprise any of a wide range of devices, including computer servers, network-attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or other devices capable of sending or receiving data from a data storage device.

The host DRAM 138 may optionally include a host memory buffer (HMB) 150. The HMB 150 is a portion of the host DRAM 138 that is allocated to the data storage device 106 for exclusive use by a controller 108 of the data storage device 106. For example, the controller 108 may store mapping data, buffered commands, logical to physical (L2P) tables, metadata, and the like in the HMB 150. In other words, the HMB 150 may be used by the controller 108 to store data that would normally be stored in a volatile memory 112, a buffer 116, an internal memory of the controller 108, such as static random access memory (SRAM), and the like. In examples where the data storage device 106 does not include a DRAM (i.e., optional DRAM 118), the controller 108 may utilize the HMB 150 as the DRAM of the data storage device 106.

The data storage device 106 includes the controller 108, NVM 110, a power supply 111, volatile memory 112, the interface 114, a write buffer 116, and an optional DRAM 118. In some examples, the data storage device 106 may include additional components not shown in FIG. 1 for the sake of clarity. For example, the data storage device 106 may include a printed circuit board (PCB) to which components of the data storage device 106 are mechanically attached and which includes electrically conductive traces that electrically interconnect components of the data storage device 106 or the like. In some examples, the physical dimensions and connector configurations of the data storage device 106 may conform to one or more standard form factors. Some example standard form factors include, but are not limited to, 3.5″ data storage device (e.g., an HDD or SSD), 2.5″ data storage device, 1.8″ data storage device, peripheral component interconnect (PCI), PCI-extended (PCI-X), PCI Express (PCIe) (e.g., PCIe x1, x4, x8, x16, PCIe Mini Card, MiniPCI, etc.). In some examples, the data storage device 106 may be directly coupled (e.g., directly soldered or plugged into a connector) to a motherboard of the host device 104.

Interface 114 may include one or both of a data bus for exchanging data with the host device 104 and a control bus for exchanging commands with the host device 104. Interface 114 may operate in accordance with any suitable protocol. For example, the interface 114 may operate in accordance with one or more of the following protocols: advanced technology attachment (ATA) (e.g., serial-ATA (SATA) and parallel-ATA (PATA)), Fibre Channel Protocol (FCP), small computer system interface (SCSI), serially attached SCSI (SAS), PCI, and PCIe, non-volatile memory express (NVMe), OpenCAPI, GenZ, Cache Coherent Interface Accelerator (CCIX), Open Channel SSD (OCSSD), or the like. Interface 114 (e.g., the data bus, the control bus, or both) is electrically connected to the controller 108, providing an electrical connection between the host device 104 and the controller 108, allowing data to be exchanged between the host device 104 and the controller 108. In some examples, the electrical connection of interface 114 may also permit the data storage device 106 to receive power from the host device 104. For example, as illustrated in FIG. 1, the power supply 111 may receive power from the host device 104 via interface 114.

The NVM 110 may include a plurality of memory devices or memory units. NVM 110 may be configured to store and/or retrieve data. For instance, a memory unit of NVM 110 may receive data and a message from controller 108 that instructs the memory unit to store the data. Similarly, the memory unit may receive a message from controller 108 that instructs the memory unit to retrieve data. In some examples, each of the memory units may be referred to as a die. In some examples, the NVM 110 may include a plurality of dies (i.e., a plurality of memory units). In some examples, each memory unit may be configured to store relatively large amounts of data (e.g., 128 MB, 256 MB, 512 MB, 1 GB, 2 GB, 4 GB, 8 GB, 16 GB, 32 GB, 64 GB, 128 GB, 256 GB, 512 GB, 1 TB, etc.).

In some examples, each memory unit may include any type of non-volatile memory devices, such as flash memory devices, phase-change memory (PCM) devices, resistive random-access memory (ReRAM) devices, magneto-resistive random-access memory (MRAM) devices, ferroelectric random-access memory (F-RAM), holographic memory devices, and any other type of non-volatile memory devices.

The NVM 110 may comprise a plurality of flash memory devices or memory units. NVM Flash memory devices may include NAND or NOR-based flash memory devices and may store data based on a charge contained in a floating gate of a transistor for each flash memory cell. In NVM flash memory devices, the flash memory device may be divided into a plurality of dies, where each die of the plurality of dies includes a plurality of physical or logical blocks, which may be further divided into a plurality of pages. Each block of the plurality of blocks within a particular memory device may include a plurality of NVM cells. Rows of NVM cells may be electrically connected using a word line to define a page of a plurality of pages. Respective cells in each of the plurality of pages may be electrically connected to respective bit lines. Furthermore, NVM flash memory devices may be 2D or 3D devices and may be single level cell (SLC), multi-level cell (MLC), triple level cell (TLC), or quad level cell (QLC). The controller 108 may write data to and read data from NVM flash memory devices at the page level and erase data from NVM flash memory devices at the block level.

The power supply 111 may provide power to one or more components of the data storage device 106. When operating in a standard mode, the power supply 111 may provide power to one or more components using power provided by an external device, such as the host device 104. For instance, the power supply 111 may provide power to the one or more components using power received from the host device 104 via interface 114. In some examples, the power supply 111 may include one or more power storage components configured to provide power to the one or more components when operating in a shutdown mode, such as where power ceases to be received from the external device. In this way, the power supply 111 may function as an onboard backup power source. Some examples of the one or more power storage components include, but are not limited to, capacitors, super-capacitors, batteries, and the like. In some examples, the amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components also increases.

The volatile memory 112 may be used by controller 108 to store information. Volatile memory 112 may include one or more volatile memory devices. In some examples, controller 108 may use volatile memory 112 as a cache. For instance, controller 108 may store cached information in volatile memory 112 until the cached information is written to the NVM 110. As illustrated in FIG. 1, volatile memory 112 may consume power received from the power supply 111. Examples of volatile memory 112 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, LPDDR4, and the like)). Likewise, the optional DRAM 118 may be utilized to store mapping data, buffered commands, logical to physical (L2P) tables, metadata, cached data, and the like in the optional DRAM 118. In some examples, the data storage device 106 does not include the optional DRAM 118, such that the data storage device 106 is DRAM-less. In other examples, the data storage device 106 includes the optional DRAM 118.

Controller 108 may manage one or more operations of the data storage device 106. For instance, controller 108 may manage the reading of data from and/or the writing of data to the NVM 110. In some embodiments, when the data storage device 106 receives a write command from the host device 104, the controller 108 may initiate a data storage command to store data to the NVM 110 and monitor the progress of the data storage command. Controller 108 may determine at least one operational characteristic of the storage system 100 and store at least one operational characteristic in the NVM 110. In some embodiments, when the data storage device 106 receives a write command from the host device 104, the controller 108 temporarily stores the data associated with the write command in the internal memory or write buffer 116 before sending the data to the NVM 110. Controller 108 may include circuitry or processors configured to execute programs for operating the data storage device 106.

The controller 108 may include an optional second volatile memory 120. The optional second volatile memory 120 may be similar to the volatile memory 112. For example, the optional second volatile memory 120 may be SRAM. The controller 108 may allocate a portion of the optional second volatile memory to the host device 104 as controller memory buffer (CMB) 122. The CMB 122 may be accessed directly by the host device 104. For example, rather than maintaining one or more submission queues in the host device 104, the host device 104 may utilize the CMB 122 to store the one or more submission queues normally maintained in the host device 104. In other words, the host device 104 may generate commands and store the generated commands, with or without the associated data, in the CMB 122, where the controller 108 accesses the CMB 122 in order to retrieve the stored generated commands and/or associated data.

During model loading, commands from a host device may still arrive at the data storage device. The model loading involves a large sequential read that should happen as fast as possible. Due to the size of the sequential read, not all commands can be processed during the model loading. As discussed herein, the data storage device determines what type of command arrives and then prioritizes the commands. Specifically, the data storage device prioritizes paging commands.

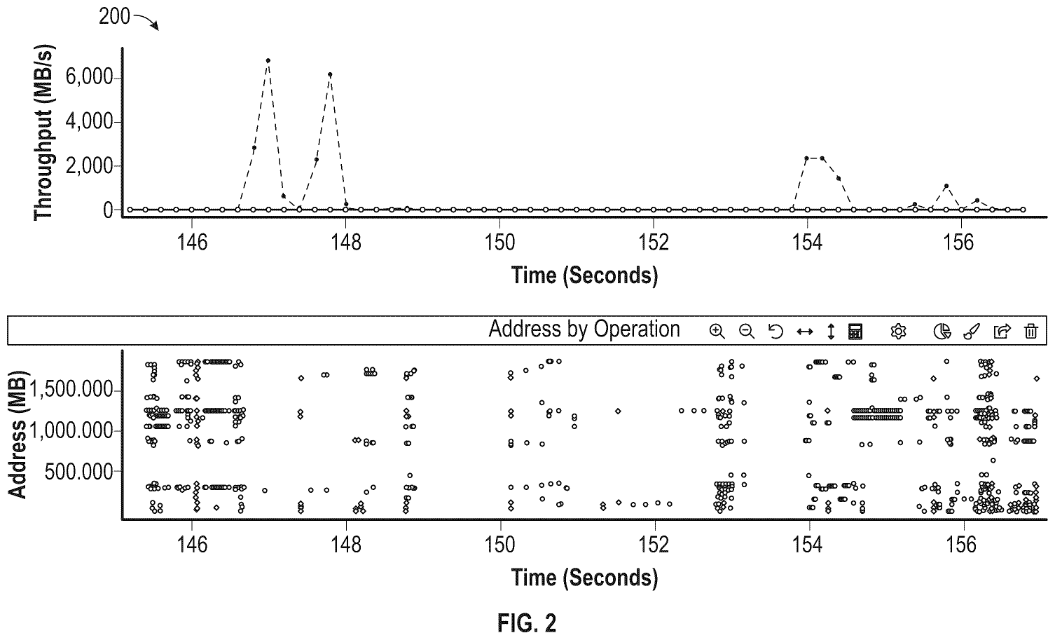

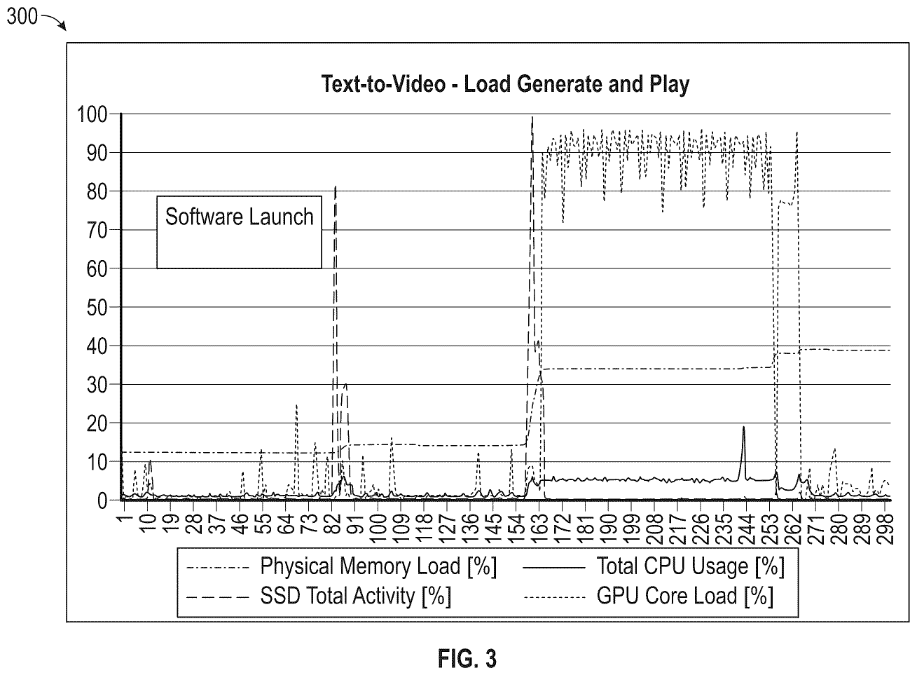

FIG. 2 is a schematic illustration 200 of a storage trace according to one embodiment. FIG. 2 shows a trace taken using a model load that is 5.34 GB in size, and loaded at a speed of 7 GB/s. As can be seen from the graph, the process starts with loading the models (the two spikes in the beginning). In another example of a text-to-video open source model 300, shown in FIG. 3, the model load also occurs at the beginning of the trace, followed by GPU and DRAM activity.

Currently, models used in endpoint activities fit into 16 GB of host memory. Microsoft has set this as a baseline recommendation for new AI PCs, and does not have new storage requirements for 2024-2025 platforms. However, model sizes are expected to increase, and more models are being deployed as the use cases become more popular in the industry. Increasing AI workloads will pressure DRAM and cause the model size to exceed available memory. Inevitably, DRAM that is already in use by applications and operating system caches will be swapped to make room for larger models. When done incorrectly, swapping can lead to responsiveness issues as the data storage device is not aware of which I/Os to prioritize effectively.

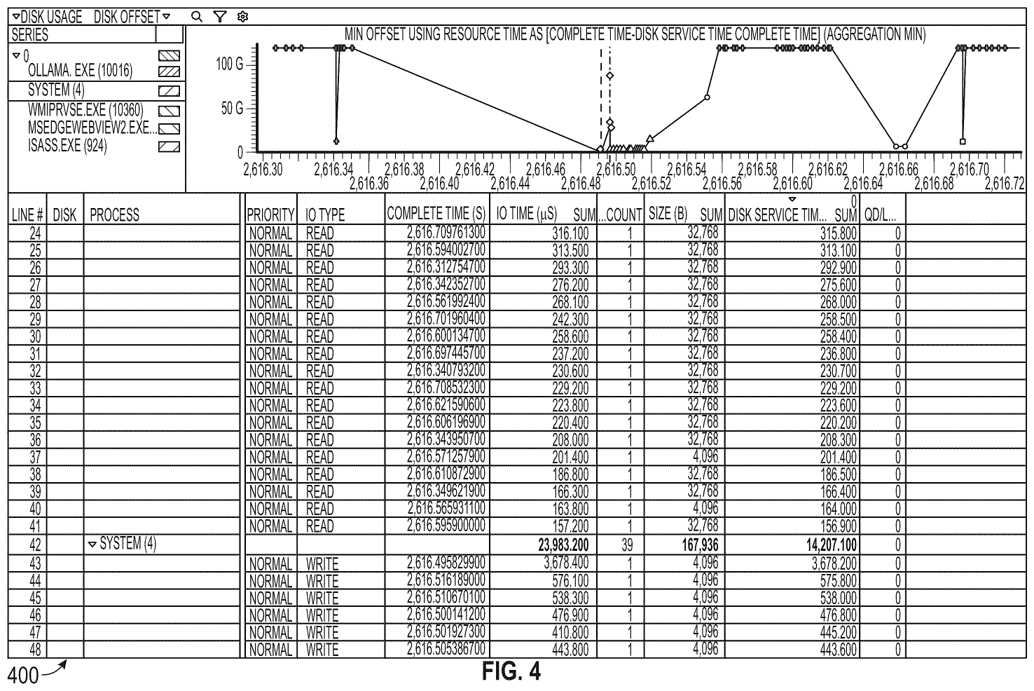

FIG. 4 is a schematic illustration 400 of model loading with paging according to one embodiment. FIG. 4 shows an example of paging activity during a model load. In this example, the data storage device is loading a model (upper dots, 32 KB read operations) and the system is paging to free up memory (lower dots, 4 KB write operations).

At present, cloud-based systems do not require any local resources. This is a new industry, and will gradually move to the endpoint. Client OEMs are designing their upcoming platforms for 16 GB of memory and evaluating larger memory footprints, but the cost of DRAM and the application service provider (ASP) of host platforms does not permit infinite growth.

As discussed herein, an operating mode is proposed that is specifically designed for model loading. In this operating mode, the model load is prioritized, but special handling is added for paging activity triggered by DRAM pressure during the model load. Paging activity may be identified, among other methods, by writes with host memory addresses which are adjacent to those being populated by previous sequential reads.

Paging is caused by an operating system freeing up virtual memory to make room for new allocations that exceed the amount of free physical memory available. This is a well-known feature in all modern operating systems. Furthermore, the description here will focus on multi-tiered client NVMe SSDs, but the same principles can be applied to other storage types and protocols.

AI models in client environments use regular file semantics, and are loaded using regular block I/O. The illustrative code below shows how a model is loaded from a file into memory.

```
void LoadModel( )
{
  // load the model
  printf(“Loading modelfile ‘%ws’ on the ‘%s’ device\n”,
modelPath.c_str( ), deviceName.c_str( ));
  DWORD ticks = GetTickCount( );
  model = LearningModel::LoadFromFilePath(modelPath);
  ticks = GetTickCount( ) − ticks;
  printf(“model file loaded in %d ticks\n”, ticks);
}
```

The model is loaded in its entirety into DRAM during the function call. Once resident, the operating system needs to balance memory usage and may start paging out other content in a memory-constrained environment. The instant disclosure addresses SSD optimizations around this behavior.

Operating systems allow overprovisioning of physical memory by swapping unused memory pages to a swap file. Paging I/O tends to have the following identifiable characteristics: write at high priority of an existing page, sometimes followed immediately by a read from a different location; and fixed location (swap files and page files are in a known partition or fixed file).

Paging I/O is not typically grouped into specific queues. As discussed herein, paging I/O is segregated and kept prioritized above non-paging I/O during a model load sequence.

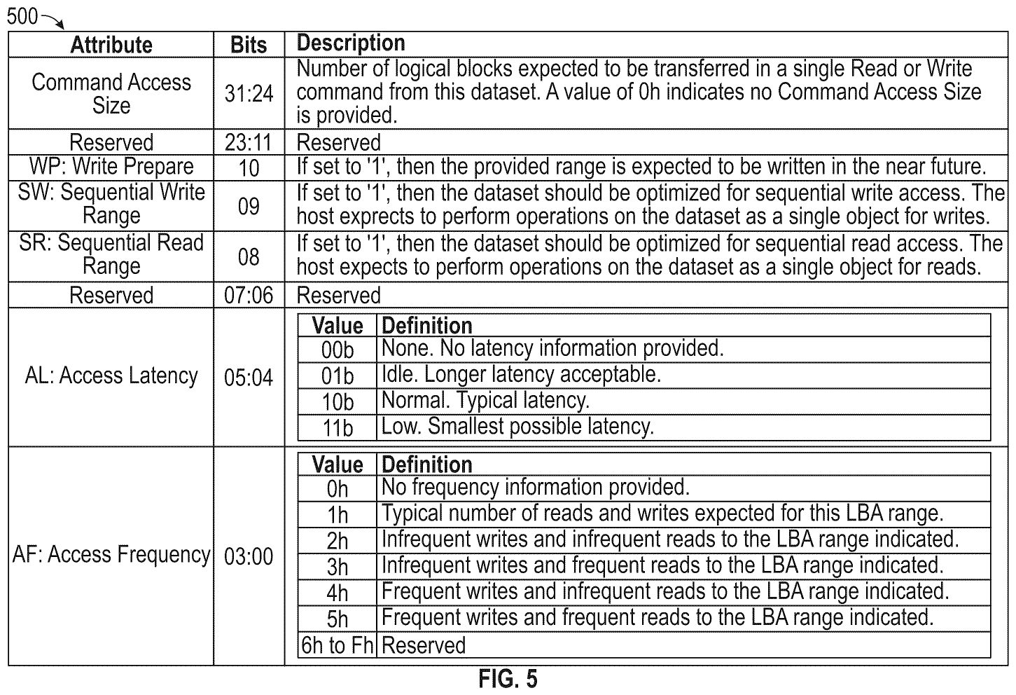

In one embodiment, paging I/O is identified using host-side context attributes sent during or subsequent to the write of a page file or other range. Context attributes are defined in the NVMe specification as shown in FIG. 5. Example attributes that may be used to indicate paging I/O may include an AL of 11b or AF of 5 h. FIG. 5 is an illustration 500 of nonvolatile memory express (NVMe) dataset management context attributes.

In another example of identification, an internal profiling operation within the data storage device can be used to identify synchronous writes (i.e., with a QD of 1) to the same ranges over time. Swap file ranges in client hosts that have limited memory will show a higher concentration of synchronous writes in specific areas, which will allow the data storage device to infer that the writes are paging ranges. Other identification methods known in the art, such as unassisted hinting, may be used as well.

In NVMe, read and write commands apply to host memory ranges. Paging operations may be used to evict data from a specific memory range (e.g., a write command) followed closely by a model load to the same range (e.g., a read command). In one embodiment, the host memory address used for a write will be used to identify the write command as a paging I/O, and priority will be given to writes in ranges near a previous read to allow for more efficient swapping. As an example, ranges near a previous read may be within the same 16 MB range, for example, to permit some reordering. Once identified, I/O prioritization is selectively applied when a model load is incurred. A model load can be identified by a large sequential read or via the file identification methods described above.

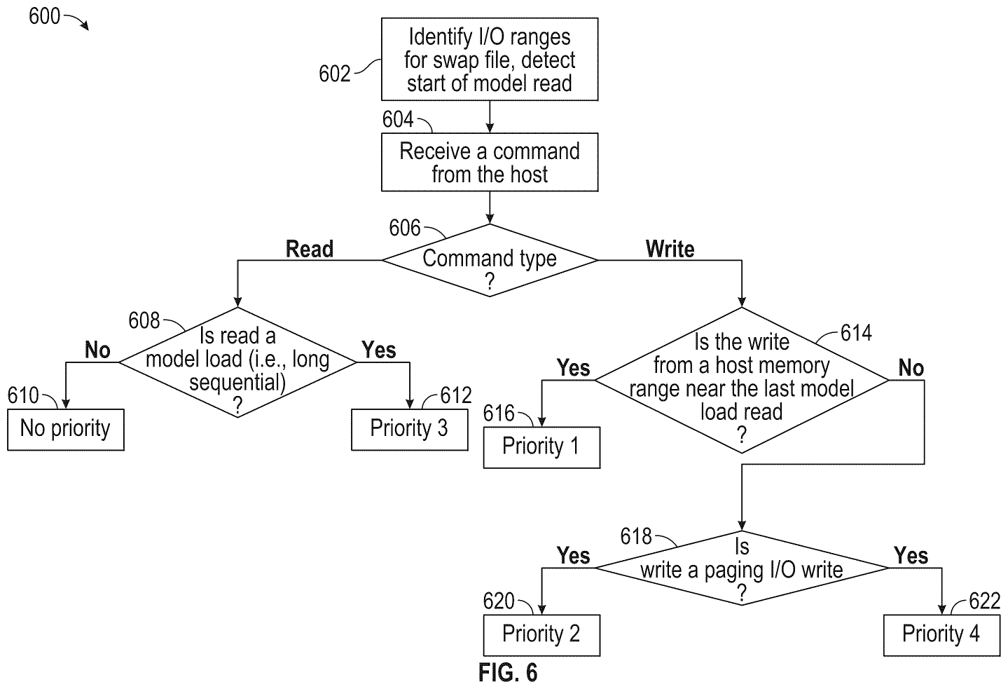

FIG. 6 is a flowchart 600 illustrating prioritizing commands during model loading according to one embodiment. The flowchart 600 may be applied to prioritize I/O during model loads. Initially, the data storage device identifies I/O ranges for swapping files and detects the start of a model read at block 602. The data storage device may continue to receive commands during the model loading and, at block 604, does receive a command. The data storage device then determines the command type at block 606. If the command is a read command, then the data storage device determines if the read command is to read a model load (i.e., the command is for a long sequential read) at block 608. An example of a long sequential read is at least half of the maximum data transfer size (MDTS) for a single read that is at least three consecutive ranges. If the read command is not a long sequential read command, then there is no priority given to the read command at block 610, but if the read command is a long sequential read command, hence presumed to be a model load, then the read command is given 3^{rd} priority at block 612.

If the command is a write command, then the data storage device determines if the write command is from a host memory range near the last model load read at block 614. If the write command is near the last model load read, then the write command is given the highest priority at block 616. If not, then the data storage device determines if the write command is a paging I/O write command at block 618. If the write command is a paging I/O write command, then the write command is given 2^{nd} priority at block 620, but 4^{th} priority at block 622 if the write command is not a paging I/O write command.

Thus, the data storage device arranges the commands in the following priority order from highest priority to lowest priority: write commands from a host memory range near the last model load read; paging I/O write commands that are not from host memory ranges near the last model load read; long sequential read commands (i.e., model loads); write commands that are not paging I/O write commands and not from host memory ranges near the last model load read; and finally, read commands that are not long sequential reads.

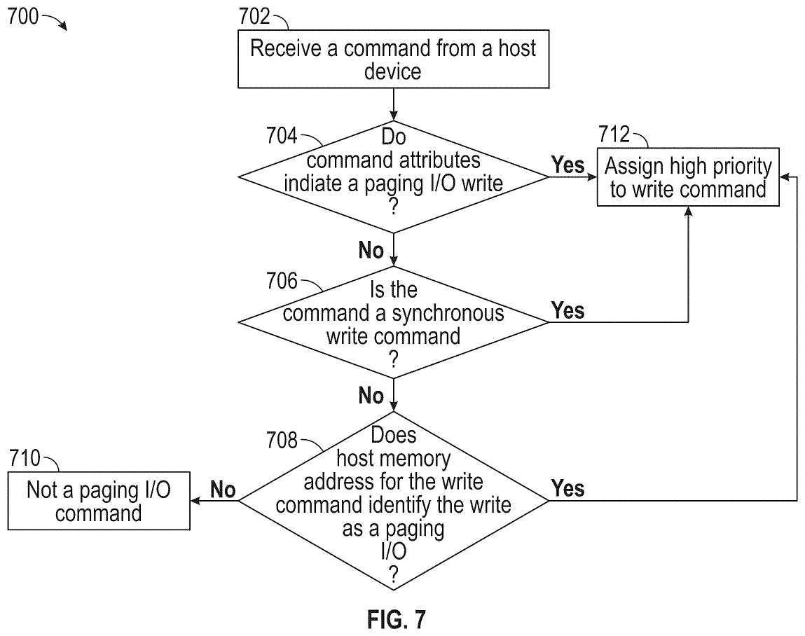

FIG. 7 is a flowchart 700 illustrating identification of a paging I/O write command according to one embodiment. Initially, the data storage device receives a write command from a host device at block 702. The data storage device then determines whether the write command attributes indicate the write command is a paging I/O write command at block 704. If yes, then the write command is given a high priority at block 712. If no, then the data storage device determines whether the write command is a synchronous write command at block 706. If yes, then the command is a paging I/O write command and given a high priority at block 712. If no, then the data storage device determines if the host memory address for the write command identifies the write command as a paging I/O write command at block 708. If yes, then the write command is a paging I/O write command and given a high priority at block 712. If no, then the write command is not a paging I/O command at block 710. It is to be understood that blocks 704, 706, and 708 may be performed in any order.

By prioritizing commands during model loading, better efficiency in AI model loading is achieved in client environments.

In one embodiment, a data storage device comprises: a memory device; and a controller coupled to the memory device, wherein the controller is configured to: perform a model load operation; receive a command from a host device during the performing; determine whether the command is a paging input/output (I/O) write command, wherein the determining occurs during the performing; and prioritize command execution based upon the determination, wherein the prioritizing occurs during the performing. The controller is further configured to determine whether the command is a read command or a write command. The controller is further configured to determine that the command is a read command, and wherein the controller is configured to determine whether the read command is a new model load. The controller is configured to assign a higher priority to the new model load compared to a read command that is not the new model load. The controller is further configured to determine that the command is a write command, and wherein the controller is configured to determine whether the write command is from a host device memory range that is near a last model load read. The controller is configured to assign a higher priority to write commands that are near the last model load read as compared to write commands that are not near the last model load read. The controller is configured to assign a higher priority to paging I/O write commands as compared to write commands that are not near the last model load read and are not paging I/O write commands. The prioritizing comprises prioritizing write commands near a last model load read, write commands that are paging I/O write commands, write commands that are not paging I/O write commands, read commands that are for model loading, and read commands that are not for model loading. Write commands that are near the last model load read have a higher priority than write commands that are paging I/O write commands, and wherein write commands that are paging I/O write commands have higher priority than write commands that are not paging I/O write commands. Read commands that are for model loading have a higher priority than read commands that are not for model loading. Read commands that are for model loading have a higher priority than write commands that are not for paging I/O write commands.

In another embodiment, a data storage device comprises: a memory device; and a controller coupled to the memory device, wherein the controller is configured to: receive a plurality of write commands from a host device; determine and set priority for the plurality of write commands; and execute at least one write command of the plurality of write command while performing a model loading operation, wherein at least a second write command of the plurality of write commands is executed after performing the model loading operation. Determining and setting the priority comprises determining whether any command of the plurality of write commands contain attributes indicating a paging input/output (I/O) write command. The determining and setting the priority comprises determining if any command of the plurality of write commands is a synchronous write command. The determining and setting the priority comprises determining if any command of the plurality of write commands has a host memory address that identifies a command as a paging input/output (I/O) write command. The controller is configured to identify long sequential read commands and prioritize the long sequential read commands after paging input/output (I/O) write commands. The controller is configured to prioritize write commands from a host memory range near a last model load read as compared to paging input/output (I/O) write commands.

In another embodiment, a data storage device comprises: means to store data; and a controller coupled to the means to store data, wherein the controller is configured to: prioritize command received during a model load operation, wherein the prioritizing comprises taking into consideration the following: whether the command is a long sequential read command; whether the command is a write command from a host memory range near a last model load read; and whether the command is a paging input/output (I/O) write command. The controller is configured to identify host side context attributes. The controller is configured to identify synchronous writes to a same range over time.

While the foregoing is directed to embodiments of the present disclosure, other and further embodiments of the disclosure may be devised without departing from the basic scope thereof, and the scope thereof is determined by the claims that follow.

What is claimed is:

1. A data storage device, comprising:
a memory device; and
a controller coupled to the memory device, wherein the controller is configured to:
perform a model load operation;
receive a command from a host device during the performing;
determine whether the command is a paging input/output (I/O) write command, wherein the determining occurs during the performing; and
prioritize command execution based upon the determination,
wherein the prioritizing occurs during the performing.

2. The data storage device of claim 1, wherein the controller is further configured to determine whether the command is a read command or a write command.

3. The data storage device of claim 2, wherein the controller is further configured to determine that the command is a read command, and wherein the controller is configured to determine whether the read command is a new model load.

4. The data storage device of claim 3, wherein the controller is configured to assign a higher priority to the new model load compared to a read command that is not the new model load.

5. The data storage device of claim 1, wherein the controller is further configured to determine that the command is a write command, and wherein the controller is configured to determine whether the write command is from a host device memory range that is near a last model load read.

6. The data storage device of claim 5, wherein the controller is configured to assign a higher priority to write commands that are near the last model load read as compared to write commands that are not near the last model load read.

7. The data storage device of claim 6, wherein the controller is configured to assign a higher priority to paging I/O write commands as compared to write commands that are not near the last model load read and are not paging I/O write commands.

8. The data storage device of claim 1, wherein the prioritizing comprises prioritizing write commands near a last model load read, write commands that are paging I/O write commands, write commands that are not paging I/O write commands, read commands that are for model loading, and read commands that are not for model loading.

9. The data storage device of claim 8, wherein write commands that are near the last model load read have a higher priority than write commands that are paging I/O write commands, and wherein write commands that are paging I/O write commands have higher priority than write commands that are not paging I/O write commands.

10. The data storage device of claim 9, wherein read commands that are for model loading have a higher priority than read commands that are not for model loading.

11. The data storage device of claim 10, wherein read commands that are for model loading have a higher priority than write commands that are not for paging I/O write commands.

12. A data storage device, comprising:
a memory device; and
a controller coupled to the memory device, wherein the controller is configured to:
receive a plurality of write commands from a host device;
determine and set priority for the plurality of write commands; and
execute at least one write command of the plurality of write command while performing a model loading operation, wherein at least a second write command of the plurality of write commands is executed after performing the model loading operation.

13. The data storage device of claim 12, wherein determining and setting the priority comprises determining whether any command of the plurality of write commands contain attributes indicating a paging input/output (I/O) write command.

14. The data storage device of claim 12, wherein the determining and setting the priority comprises determining if any command of the plurality of write commands is a synchronous write command.

15. The data storage device of claim 12, wherein the determining and setting the priority comprises determining if any command of the plurality of write commands has a host memory address that identifies a command as a paging input/output (I/O) write command.

16. The data storage device of claim 12, wherein the controller is configured to identify long sequential read commands and prioritize the long sequential read commands after paging input/output (I/O) write commands.

17. The data storage device of claim 12, wherein the controller is configured to prioritize write commands from a host memory range near a last model load read as compared to paging input/output (I/O) write commands.

18. A data storage device, comprising:
means to store data; and
a controller coupled to the means to store data, wherein the controller is configured to:
prioritize command received during a model load operation, wherein the prioritizing comprises taking into consideration the following:
whether the command is a long sequential read command;
whether the command is a write command from a host memory range near a last model load read; and
whether the command is a paging input/output (I/O) write command.

19. The data storage device of claim 18, wherein the controller is configured to identify host side context attributes.

20. The data storage device of claim 18, wherein the controller is configured to identify synchronous writes to a same range over time.
